(19) United States
(12) Patent Application Publication
(10) Pub. No.: US 2004/0156646 A1
(43) Pub. Date: Aug. 12, 2004

(54) Image forming device

(76) Inventor: Katsuhiko Suzuki, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/770,524

(22) Filed: Feb. 4, 2004

(30) Foreign Application Priority Data
Feb. 7, 2003 (JP) 2003-030212

(51) Int. Cl. G03G 15/00; G03G 15/06

(52) U.S. Cl. 399/49; 399/55

(57) ABSTRACT

An image forming device which is provided with a developing unit for image visualizing an electrostatic latent image formed on an image carrying body by utilizing two components developing agent containing toners and carriers, transfers a toner image on a recording medium and fixes the toner image transferred on the recording medium on another recording medium to obtain a record image, which is further provided with a patch sensor for detecting an image density of the record image and controls toner density stabilization control and adjustment value and bias voltage in the developing unit according to a value detected by the patch sensor and a value of current flowing in the image carrying body from the developing unit.

Thereby, an image forming device is provided which performs a stable image density control when a problem is caused during processing of a predetermined number of printing pages, in particular, even when a deterioration of image due to abnormal property change of a developing agent is caused.

### BACKGROUND OF THE INVENTION

1. Field of the Invention

The present invention relates to an image forming device utilizing such as electro photographic method and electrostatic recording method which forms repeatedly many number of images and, more specifically, relates to an image forming device using a control unit which performs adjustment of toner density and bias voltage in a developing unit according to a value detected by a patch sensor representing image density of a recorded image and a value of current flowing in an image carrying body from the developing unit

2. Conventional Art

In a conventional recording device using electro photographic method, a photoconductive and photo sensitive body is uniformly charged, an image is exposed, a partial discharge of electric charges is caused on the photosensitive body and an electrostatic latent image is formed thereon. Thereafter, the electrostatic latent image is developed with toners containing coloring agents. As developing units which supply toners for the electrostatic latent image formed on the photosensitive body, other than a developing unit of one component developing type which uses only toners for the developing agent, a developing unit of two component developing type which uses a developing agent containing toners and carriers. The toner image thus obtained is transferred and fixed on a recording medium such as a recording paper to obtain a record image. And these processes are repeatedly performed

The two components type developing which uses a developing agent containing toners and carriers will be explained. When performing a development by supplying toners to a photosensitive body, since the toner density in the developing agent gradually decreases in accordance with formation of images, it is required to keep the toner density in the developing agent, therefore, when the toner density decreases to some extents, a toner replenishing unit is driven for replenishing new toners. For this reason, a toner density control unit is required which always keeps the toner density constant.

A conventional toner density control unit will be explained. A toner density in the developing agent containing toners and carriers is measured with a toner density detector provided in a developing unit. When the output value of the detector reduces below a reference set value, it is judged that the toner density has decreased and a toner replenishing unit is driven until the value from the toner density detector reaches the reference set value so as to replenish new toners. The reference set value is determined in advance for every number of predetermined printing pages so as to supplement characteristic change of the developing agent, thus the toner density is always controlled to be constant.

A toner density control corresponding to a record image will be explained. An image density of a patch image transferred on a recording medium such as a recording paper during the transfer process is read by such a as patch sensor. The read value is fed back to a control unit such as CPU in the machine main body, and when the read image density does not reach a reference value, the toners are replenished until the reference value is reached, thereby, through the toner density control the image density of the record image is always kept constant as, for example, disclosed in JP-A-2002-23436.

In the conventional toner density control of two components type development, the toner density is controlled for every number of predetermined printing pages, and if a problem occurs during the interval, an image density of a patch image is directly detected and the detected value is fed back to the control system to control the toner density, thereby, even in the midway of the predetermined printing pages the printing quality is finely controlled. However, in the above conventional toner density control, there was a problem that when a deterioration of image density of a patch image is caused due to an abnormal property change of the developing agent, and the deterioration is countermeasured by modifying the developing conditions such as toner density and bias voltage, the property of the developing agent is further deteriorated and the image density of the record image can not kept constant.

### SUMMARY OF THE INVENTION

An object of the present invention is to provide an image forming device which performs a stable image density control when a problem is caused during processing of a predetermined number of printing pages, in particular, even when a deterioration of image due to abnormal property change of a developing agent is caused.

The above object is achieved by an electrostatic recording device which is provided with a developing unit for image visualizing an electrostatic latent image formed on an image carrying body by utilizing two components developing agent containing toners and carriers, transfers a toner image on a recording medium and fixes the toner image transferred on the recording medium on another recording medium to obtain a record image, which is further provided with a patch sensor for detecting an image density of the record image and controls toner density stabilization control and adjustment value and bias voltage in the developing unit according to a value detected by the patch sensor and a value of current flowing in the image carrying body from the developing unit.

### BRIEF DESCRIPTION OF THE DRAWING

FIG. 1 is a cross sectional view showing schematically an electro photographic type electrostatic recording device incorporating an embodiment of the present invention.

### DESCRIPTION OF AN EMBODIMENT

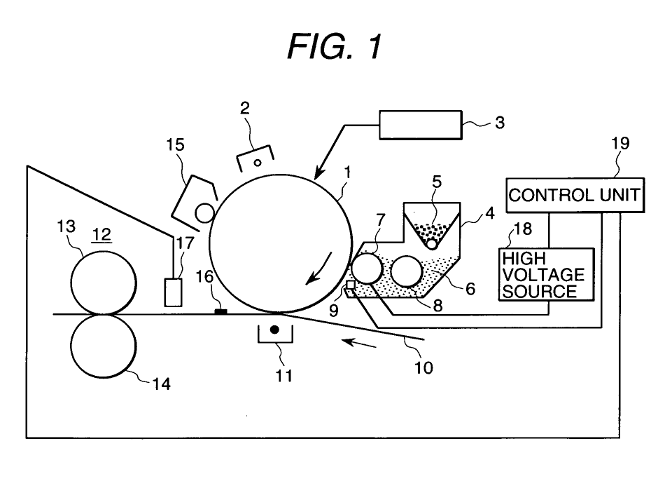

Herein below an embodiment of the present invention will be explained with reference to FIG. 1.

FIG. 1 is a view showing schematically a cross section of an electrostatic recording device representing the present invention. With this drawing, processes performed by the present device will be explained. A photosensitive body 1 having photoconductivity is uniformly charged by an electro static charger 2 and forms a latent image through laser beams from an optical device 3. Thereafter, a developing unit 4 disposed near the photosensitive body 1 and facing thereto develops the latent image by using a developing agent composed of toners 5 and carriers in a manner by transporting the developing agent 6 from a transporting roll 8 to a developing roll 7, by applying a bias voltage having a same polarity as the charge polarity of the toner 5 between the photosensitive body 1 and the developing roll 7 and by contacting the developing agent 6 to the photosensitive body 1.

After completing a development, the developing agent 6 inters into a toner density detector 9 disposed near the developing roll 7 and a ratio of the toners 5 in the developing agent 6 is detected. The toners developed and deposited on the surface of the photosensitive body 1 are transferred on a sheet 10 by means of an image transfer unit 11, which applies to the toners 5 an opposite polarity from the charge polarity of the toners 5. The toners 5 transferred on the sheet 10 are fixed on the sheet 10 by means of a fixing unit 12 which is constituted by a heat roll 13 for providing heat to the toner 5 and a pressure roll 14 for applying a pressure onto the toners 5 on the sheet 10 and onto the heat roll 13 to thereby form a final image.

On one hand, toners 5 not being transferred and remained on the photosensitive body 1 are removed from the surface of the photosensitive body 1 by a cleaning unit.

A patch sensor 17 which detects an image density of a recorded image transferred on the sheet 10 by the image transfer unit 11 is disposed between the image transfer unit 11 and the fixing unit 17. A patch image 16 used for detecting the image density of the recorded image is developed, a density of the patch image 16is read by the patch sensor 17 and the image density of the recorded image is detected.

Further, a high voltage power source 18 which applies the bias voltage to the developing roll 7 in the developing unit 4 is disposed near the developing unit 4 and is connected to a control unit 19 such as a CPU which permits to detect a current flowing to the photosensitive body 1 from the developing roll 7.

The patch sensor 17 is also connected to the control unit 19 to which the image density of the patch image 16 is always inputted. Developing conditions are controlled based on these input data. And the above processes are performed repeatedly.

An image quality stabilization control means of the present invention will be explained. An image density of the recorded image is detected by the patch sensor 17, and the detected value is fed back to the control unit 19. The value is compared with an image density reference range set in the control unit 19 and when the image density detected value is within the image density reference range, the printing operation is continued.

An instance where the image density detection value is deviated from the image density reference range due to any one of reasons will be explained. An instance where the detection value exceeds the upper limit value of the image density reference range will be explained. In this instance because the image density is dense, the detection value exceeds the image density reference range. First, the printing operation is temporarily stopped, a current flowing into the photosensitive body 1 from the high voltage power source 18 applying the bias voltage is detected, which is inputted in the control unit 19 so as to confirm whether the detected value is within a reference flow-in current range.

A method of detecting the flow-in current to the photosensitive body 1 from the high voltage power source 18 will be explained briefly. A current is detected which flows in to the photosensitive body 1 through the developing agent 6 existing on the developing roll 7 in the developing unit 4 disposed facing the photosensitive body 1. The detection method is that the photosensitive body 1 is charged to a predetermined voltage and thereafter the bias voltage applied to the developing unit is rendered to 0V. The current value at this moment is detected which is inputted to the control unit 19. Since this flow-in current is one, which flows into the developing unit 4 through the developing agent 6, the detected flow-in current can be converted into a resistance value of the developing agent 6.

In the above manner, it is judged whether the flow-in current inputted into the control unit 19 is within the flow-in current reference range set in the control unit. When the detected flow-in current is within the set reference range, both the bias voltage and the toner density, which represents the toner ratio in the developing agent 6 are controlled so that the image density of the recorded image restores within the image density reference range set in the control unit 19. Further, when the detected flow-in current value exceeds the upper limit value of the flow-in current reference range, only the bias voltage is controlled so as to try that the image density of the recorded image restores within the image density reference range set in the control unit 19.

As has been explained above, since the flow-in current can be converted into a resistance value of the developing agent 6, the instance where the flow-in current exceeds over the upper limit value of the flow-in current reference range implies that the resistance of the developing agent has decreased. In this instance, since the resistance of the developing agent is reduced, the image density becomes dense and exceeds beyond the image density reference range set in the control unit 19. Accordingly, when a control for reducing the toner density is performed, since the resistance of the developing agent further reduces, the image density of the record image may not be sometimes restored. For this reason, through the control of only the bias voltage the restoration of the image density within the image density reference range is tried. With this bias voltage control if the image density is not restored within the reference range, the toner density control is added. On the other hand, when the detected flow-in current exceeds the lower limit of the flow-in current reference range, in the like manner as above but in the opposite direction, through the control of only the bias voltage the restoration of the image density within the image density reference range is tried. If the trial to restoration fails with the bias voltage control, the toner control is also performed.

According to the present invention, even if a problem due to abnormality in developing agent property is caused during a predetermined number of printing operations because of any one of reasons, a stable image density control which countermeasures the problem can be provided. Further, a image density stabilization control using such as a patch sensor can always provide a stable image density, even if a change is caused due to abnormality in developing agent property.

1. An image forming device which is provided with a developing unit for image visualizing an electrostatic latent image formed on an image carrying body by utilizing two components developing agent containing toners and carriers, transfers a toner image on a recording medium and fixes the toner image transferred on the recording medium on another recording medium to obtain a record image, which is further provided with a patch sensor for detecting an image density of the record image and controls a stabilization control and adjustment value of toner density in the developing unit and bias voltage between the image carrying body and the developing unit according to a value detected by the patch sensor and a value of current flowing in the image carrying body from the developing unit.

2. An image forming device according to claim 1, wherein when a detected value of current flowing in the image carrying body from the developing unit exceeds a flow-in current reference range, the bias voltage between the image carrying body and the developing unit is for the first time controlled so as to restore the image density of the record image.
